(19) United States
(12) Patent Application Publication
(10) Pub. No.: US 2017/0257226 A1
(43) Pub. Date: Sep. 7, 2017

(54) Method for Detecting the Status of a Home Automation Device

(71) Applicant: Wireless Input Technology, Inc., Wilmington, DE (US)

(72) Inventor: Gang Bi, Grayslake, IL (US)

(73) Assignee: Wireless Input Technology, Inc., Wilmington, DE (US)

(21) Appl. No.: 15/061,985

(22) Filed: Mar. 4, 2016

(51) Int. Cl. H04L 12/28; H04L 29/08; H04L 12/26

(52) U.S. Cl. CPC H04L 12/2827; H04L 43/10; H04L 67/10

(57) ABSTRACT

This invention discloses a method of using a cloud server to remotely detect the status of a home automation gateway of a home security and automation network. According to this invention, the home automation gateway of the home security and automation network periodically sends heartbeat packets to a cloud server. The cloud server monitors the reception of all these heartbeat packets, records relevant information contained in these heartbeat packets in a database, and updates the most recent status of the particular home automation gateway. If the cloud server has not received any heartbeat packets from the home automation gateway for more than a predetermined time period, the cloud server considers the home automation gateway currently offline and notifies the user of the home security and automation network by sending a notification message to the user's mobile device.

### FIELD OF INVENTION

This invention generally relates to smart home security and automation technology. More specifically, this invention relates to a method for detecting the status of a home automation device.

### BACKGROUND OF THE INVENTION

Home automation and security networks allow users to remotely monitor their homes, receive security alerts, and control the various devices and/or appliances from mobile devices (e.g., smartphones). Thus, they are gaining popularity among consumers. These networks could be Zigbee, Z-wave, or Wi-Fi based networks, or combinations of these networks. Such a home automation and security network usually includes one or more battery-powered smart devices equipped with sensors for home security protection and one or more stand-alone smart home appliances. Typically, the battery-powered smart devices operate on the Zigbee or Z-wave protocol for power conservation. The stand-alone smart home appliances operate on the Wi-Fi protocol. A home automation gateway is needed to act as a communication bridge between these battery-powered smart devices and any external network server or device. For example, if any battery-powered smart device detects any sensor triggering event, the battery-powered device sends an alarm signal to the home automation gateway, which reports the alarm to the user's mobile device via an external network. Typically, the home automation gateway and the stand-alone smart home appliances are powered by 110v/220v external power source due to high power consumption. Thus, if there is a power outage, the home automation gateway or any stand-alone smart home appliance will be offline. As such, communication between the home automation and security network and any external network will be cut off. Currently, if such an event occurs, the user will not be aware of it because the home automation and security network won't be able to notify the user.

Thus, a new mechanism is needed so that when a home automation gateway or a stand-alone smart home appliance is powered down or offline the user is aware of the event without substantial delay.

### SUMMARY OF THE INVENTION

In one embodiment of the present invention, a home automation gateway or a stand-alone smart home appliance (together, a “home automation device”) of a home security and automation network periodically sends heartbeat packets to a cloud server. The cloud server monitors the reception of these heartbeat packets, records relevant information contained in these heartbeat packets in a database, and updates the most recent status of the particular home automation device. If the cloud server has not received any heartbeat packets from the home automation device for more than a predetermined time period, the cloud server considers the home automation device currently offline and notifies the user by sending a notification message to the user's mobile device.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the leftmost digit of a reference number identifies the drawing in which the reference number first appears.

FIG. 1 is a system diagram illustrating a home security and automation network according to some embodiments of the present invention.

FIG. 2 is a functional block diagram of a cloud server according to some embodiments of the present invention.

FIG. 3 is a flow diagram illustrating a process of determining whether a home automation device is currently offline according to some embodiments of the present invention.

### DETAILED DESCRIPTION

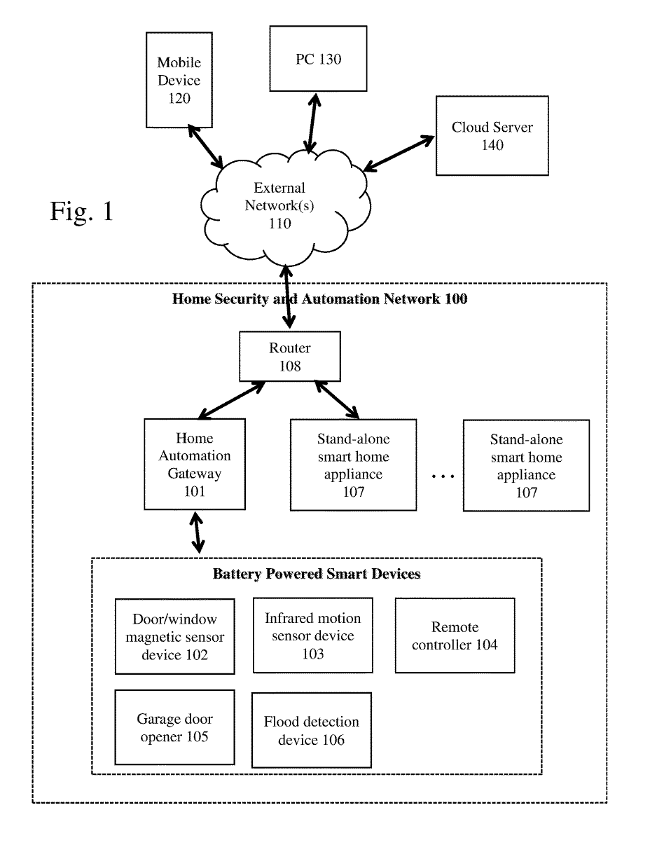

FIG. 1 is a system diagram of a home security and automation network 100. As shown, the home security and automation network 100 includes a home automation gateway 101, one or more battery powered smart devices, including but not limited to a door/window magnetic sensor device 102, an infrared motion sensor device 103, a remote controller 104, a garage door opener 105, and a flood detection device 106, one or more stand-alone smart home appliances 107, and a router 108.

In one embodiment, the home automation gateway 101 functions as the hub as well as the gateway for the one or more battery powered smart devices 102-106. As a hub, it establishes a personal area network (e.g., Zigbee, Z-wave) to connect the one or more battery powered smart devices 102-106, stores information about the personal area network such as security keys, and forward data packets. As a gateway, it serves as a bridge between the one or more battery powered smart devices 102-106 and external network(s) 110 and handles the data traffic coming into or going out of the personal area network. Typically, the one or more stand-alone smart home appliances 107 operate on the Wi-Fi protocol. Thus, they do not need a gateway to communicate with the Internet. The router 108 serves as a traffic switch for the home automation gateway 101 and the one or more stand-alone smart home appliances 107.

The home automation gateway 101 is typically powered by 110v/220v external power source due to high power consumption. In another embodiment, the home security and automation network 100 may have two separate machines—one functions as the gateway and the other functions as the hub.

The door/window magnetic sensor device 102, infrared motion sensor device 103, garage door opener 105, and flood detection device 106 are typically battery-powered devices. Each of these devices has a sensor for detecting a sensor triggering event. For example, a sensor triggering event for the door/window magnetic sensor device 102 may be the opening or closing of the door or window; a sensor triggering event for the infrared motion sensor device 103 may be a human or animal moving within a certain spatial range near the device; and a sensor triggering event for the flood detection device 106 may be that water has submerged the sensor of the device. As shown in FIG. 1, a smart device can communicate with the home automation gateway 101 directly.

The remote controller 104 provides functions for controlling various other smart devices, such as turning on/off the garage door opener 105 to open/close the garage door, etc. It is also typically battery-powered. The remote controller 104 has a user input interface such as a touchscreen or keypad for receiving commands.

Also as shown in FIG. 1, the home security and automation network 100 may be remotely monitored and/or controlled by a mobile device 120 or a personal computer (PC) 130 via the external network(s) 110, which may include wired or wireless, local or wide area network(s) (e.g., Wi-Fi, Ethernet, Internet). In one embodiment, a user may configure the mobile device 120 (e.g., a smartphone, tablet computer) or the PC 130 to receive security alerts sent from the home security and automation network 100 and to control the various smart devices in his house.

In another embodiment, the mobile device 120 and PC 130 may communicate with the home security and automation network 100 via a cloud server 140, which may offload certain responsibilities from the mobile device 120, the PC 130, and/or the home security and automation network 100. In addition, the cloud server 140 may integrate various other services and functions, including but not limited to account management, access control, equipment monitoring, software/firmware upgrade, data storage, and data security. Users can even choose which cloud server to use based on their geographical locations.

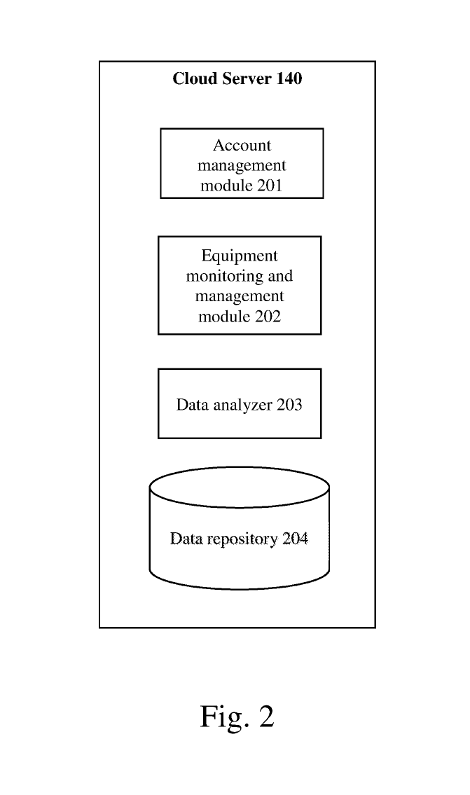

FIG. 2 is a functional block diagram of a cloud server 140. In one embodiment, the cloud server 140 includes an account management module 201, an equipment monitoring and management module 202, a data analyzer 203, and a data repository 204. Although it is shown as a single box in FIG. 2, the cloud server 140 may be implemented on one server machine or multiple server machines. The various modules or components of the cloud server 140 may be implemented by software, hardware, or a combine of software and hardware.

The account management module 201 provides the function for managing user account information, including but not limited to user profile, subscription, and billing. The equipment monitoring and management module 202 provides various functions for a user to monitor and manage the home security and automation network and its various devices. For example, through the equipment monitoring and management module 202, a user can check whether the home automation gateway 101, any smart device, or any stand-alone smart home appliance in the network is currently online or offline, set a wake-up schedule for any particular device, or turn on/off any particular device. A user can access the account management module 201 and the equipment monitoring and management module 202 from a mobile device or a personal computer remotely.

The data repository 204 stores the user account information described above. It may also store the operation log of a home security and automation network and its devices. The operation log may include data regarding when, why, and how long the home security and automation network or any device was offline, any triggering event occurred in the past, and any user interaction with a device. The data analyzer 203 analyzes these data to find any useful pattern that can be helpful to improve user experience.

In one embodiment, a home automation device periodically sends heartbeat packages to the cloud server 140. For example, the home automation gateway or a stand-alone smart home appliance can send a heartbeat package to the cloud server 140 every 10, 20, or 30 seconds, or other predetermined time period. A heartbeat package may contain information such as the serial number of the home automation gateway, the timestamp when the heartbeat package was sent from the home automation gateway or stand-alone smart home appliance, and other information relevant to the home automation gateway or stand-alone smart home appliance. The equipment monitoring and management module 202 receives the heartbeat package, retrieves the relevant information contained in the heartbeat package, and updates the record associated with the particular home automation gateway or stand-alone smart home appliance. The record may be stored in the data repository 204. If the cloud server 104 has not received any heartbeat packet from the particular home automation gateway or stand-alone smart home appliance for more than a certain amount of time (e.g., 30 seconds), the cloud server 104 will consider that the home automation gateway or stand-alone smart home appliance is currently offline. Upon such a determination, the cloud server 140 sends a notification message to the user's mobile device to notify the user that the home automation gateway or stand-alone smart home appliance is currently offline.

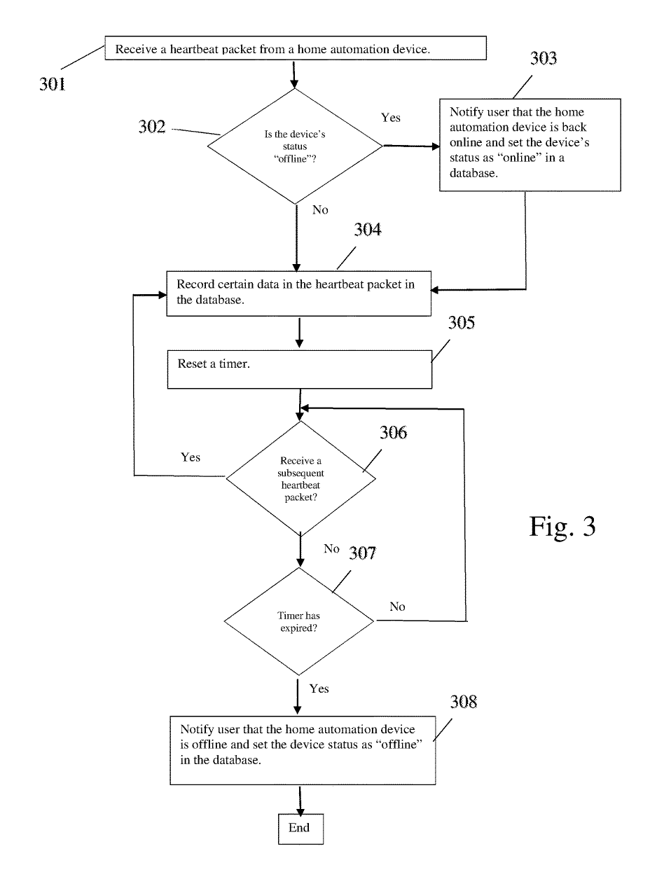

FIG. 3 is a flow diagram illustrating a process 300 of determining whether a home automation device, such as a home automation gateway or a stand-alone smart home appliance, is currently offline. In one embodiment, the process 300 is implemented by the equipment monitoring and management module 202. One or more instances of the process 300 may run on the cloud server 140 at any given time.

At step 301, the process 300 receives a heartbeat packet from a home automation device. As mentioned above, the heartbeat packet contains information such as the serial number of the home automation device and the timestamp when the heartbeat packet was sent by the home automation device. Of course, other types of information may also be contained in the heartbeat packet.

At step 302, the process 300 determines whether home automation device's most recent status is “offline.” For example, the cloud server 104 may maintain a record for each registered home automation device to indicate the most recent status of a particular device. Each record may be maintained in the data repository 204. When the process 300 receives a heartbeat packet from a home automation device, it retrieves the serial number contained in the heartbeat packet and uses the serial number to retrieve the status record for that particular home automation device. If the process 300 determines that the home automation device's most recent status is “offline,” the process 300 goes to step 303. Otherwise, it goes to step 304.

At step 303, the process 300 sends a notification message to the user's mobile device to inform the user that the home automation device has come back online. Then, the process 300 goes to step 304.

At step 304, the process 300 retrieves relevant information from the heartbeat packet and records the information in a database such as the data repository 204 shown in FIG. 2.

At step 305, the process 300 resets a timer. The timer may be set based on how frequent the home automation device sends its heartbeat packets to the cloud server 104. For example, if the device sends a heartbeat packet every 10 seconds, the timer may be set to expire after 30 seconds. Thus, before the timer expires, the cloud server 104 is supposed to receive 3 heartbeat packets from the home automation device.

At step 306, the process 300 determines whether it receives a subsequent heartbeat packet from the home automation device. If yes, the process 300 goes back to step 304 to record the information retrieved from the most recently received heartbeat packet in the database. If no, the process 300 goes to step 307.

At step 307, the process 300 determines whether the timer has expired. If yes, it means that the cloud server 104 has not received any heartbeat packet from the particular home automation device for more than the timer's time length. At such, the process 300 goes to step 308. If no, the process 300 goes back to step 306.

Alternatively, the process 300 may go into sleep at step 307. When the cloud server 140 receives a subsequent heartbeat packet from the home automation device or the timer expires, the cloud server wakes up the process 300. If a subsequent heartbeat packet has arrived, the process 300 goes to step 304. Otherwise, the process 300 goes to step 308.

At step 308, the process 300 sends a notification message to the user's mobile device to notify the user that the home automation device is currently offline. Also, the process 300 sets the home automation device's most recent status as “offline.”

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A method executed by a processor of a cloud server, the method comprising:
receiving a heartbeat packet from a home automation device;
determining that a subsequent heartbeat packet has not been received within a predetermined time period; and
sending a notification message to a mobile device to notify a user of the mobile device that the home automation device is currently offline.

2. The method of claim 1 further comprising updating a record associated with the home automation device to indicate that the home automation device's most recent status is offline.

3. The method of claim 1, wherein said determining step comprises:
setting a timer to expire after the predetermined time period; and
continuously checking whether the cloud server has received the subsequent heartbeat packet.

4. The method of claim 1, wherein the heartbeat packet includes a serial number of the home automation device and a time stamp showing when the home automation device sent out the heartbeat packet.

5. The method of claim 1, wherein the home automation device is a home automation gateway of a personal area network.

6. The method of claim 5, wherein the personal area network is a Zigbee network.

7. The method of claim 5, wherein the personal area network is a Z-wave network.

8. The method of claim 1, wherein the home automation device is a stand-alone smart home appliance.

9. A cloud server comprising:
a memory for storing instructions; and
a processor which, upon executing the instructions, performs a process comprising:
receiving a heartbeat packet from a home automation device;
determining that a subsequent heartbeat packet has not been received within a predetermined time period; and
sending a notification message to a mobile device to notify a user of the mobile device that the home automation device is currently offline.

10. The cloud server of claim 9, wherein the process further comprises updating a record associated with the home automation device to indicate that the home automation device's most recent status is offline.

11. The cloud server of claim 9, wherein said determining step comprises:
setting a timer to expire after the predetermined time period; and
continuously checking whether the cloud server has received the subsequent heartbeat packet.

12. The cloud server of claim 9, wherein the heartbeat packet includes a serial number of the home automation device and a time stamp showing when the home automation device sent out the heartbeat packet.

13. The cloud server of claim 9, wherein the home automation device is a home automation gateway of a personal area network.

14. A non-transient computer readable medium programmed with computer readable code that upon execution by a processor of a device causes the processor to:
receive a heartbeat packet from a home automation device;
determine that a subsequent heartbeat packet has not been received within a predetermined time period; and
send a notification message to a mobile device to notify a user of the mobile device that the home automation device is currently offline.

15. The non-transient computer readable medium of claim 14, wherein execution by the processor further causes the processor to update a record associated with the home automation device to indicate that the home automation device's most recent status is offline.

16. The non-transient computer readable medium of claim 14, wherein said determine step comprises:
set a timer to expire after the predetermined time period; and
continuously check whether the cloud server has received the subsequent heartbeat packet.

17. The non-transient computer readable medium of claim 14, wherein the heartbeat packet includes a serial number of the home automation device and a time stamp showing when the home automation device sent out the heartbeat packet.

18. The non-transient computer readable medium of claim 14, wherein the home automation device is a home automation gateway of a personal area network.

19. The non-transient computer readable medium of claim 18, wherein the personal area network is a Zigbee network.

20. The non-transient computer readable medium of claim 18, wherein the personal area network is a Z-wave network.
